(19) United States
(12) Patent Application Publication
(10) Pub. No.: US 2005/0279388 A1
(43) Pub. Date: Dec. 22, 2005

(54) Sink drain adapter for drain cleaning device

(76) Inventor: Randall Paul Schmitt, Clinton Township, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/872,940

(22) Filed: Jun. 21, 2004

(51) Int. Cl. B08B 9/00

(52) U.S. Cl. 134/22.1; 134/22.11; 134/166 R

(57) ABSTRACT

The present invention is a drain adapter for adapting a flushing device to a drainpipe. The adapter has a main body including an indent portion for retaining the flushing device during operation. The main body also includes an enlarged portion. The enlarged portion corresponds to a sink recess and expands under pressure to retain the adapter within the drainpipe.

### BACKGROUND OF THE INVENTION

The present invention relates to adapting a flushing device to a drainpipe.

Drainpipes in sinks occasionally become blocked and require cleaning. Flushing devices have been designed to remove debris from the drainpipe when traditional cleaning methods do not work. The flushing device is inserted into a drainpipe. The flushing device is also connected to a water source, such as a hose. Water is sent through the flushing device and a valve creates a pulsing action to the water, which removes the debris from the drain. This type of flushing device should be inserted into the drainpipe several inches in order to operate correctly. However, to deter debris from entering the drainpipe crosshatches are located just inside the drainpipe entrance. The crosshatches restrict the insertion depth of the flushing device.

Adapters are used with the flushing devices to accommodate for the abbreviated insertion distance resulting from the crosshatches. For one style of adapter, a first end of the adapter is inserted into the sink drain while the other end receives the flushing device. The adapter increases the allowable insertion distance for the flushing device such that it is sufficient to allow proper operation.

During operation, water pressure builds between the blockage and the flushing device until the blockage is removed. For blockages that are difficult to remove, the increasing water pressure creates an upward force on the adapter pushing it from the pipe. Due to the short insertion distance of the adapter, it is difficult to retain the adapter in position. Additionally, when the flushing device and water source fill with fluid. The adapter becomes top heavy and may dislodge during operation. Thus, large amounts of physical exertion by the user are needed to retain the adapter in position. Also, because of the short sealing distance between the adapter and the pipe, the increasing water pressure may cause leaks to occur between the pipe and the adapter. Thus, an adapter which has enhanced sealing capability and that is easily retained in the drainpipe is needed.

### SUMMARY OF THE INVENTION

The present invention provides an adapter for use between a flushing device and a drainpipe. The adapter has a main body. A first end of the main body has a first opening for receiving a flushing device. A second end of the main body has a second opening allowing fluid to exit the flushing device and the adapter, and enter a drainpipe.

An indent is included on the main body to correspond to recesses on the flushing device. During operation the flushing device expands within the adapter. The indent is received in one of the recesses and the expanding flushing device creates pressure against the adapter. Pressure between the flushing device walls and the indent retains the flushing device within the adapter.

The main body also includes an enlarged portion that is disposed between the indent and the second end. The enlarged portion is expandable under pressure. The size and location of the enlarged portion on the adapter corresponds to a recess in a sink bottom. The enlarged portion interacts with the sink recess to retain the adapter in an upright position during use. When water pressure builds in the pipe during operation the enlarged portion will expand from the water pressure and contact the sink recess to retain the adapter in the drainpipe. If additional pressure is needed to retain the adapter in the drainpipe the enlarged portion also provides a surface where downward pressure can be applied by the user. Thus, the adapter is retained within the drainpipe during operation with little or no exertion needed on the part of the user.

Concentric rings located on the second end of the adapter create an interference fit with the drainpipe to seal against any leaks. Any leaks that do occur are directed into a sink bottom by striations within the enlarged portion. Thus, back pressure is not created between the adapter and sink.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a general view of an embodiment of an adapter;

FIG. 2 is a cross-section along line A-A from FIG. 1, of an embodiment of the adapter showing an enlarged portion having striations;

FIG. 3 is a cross section along line B-B from FIG. 1 of an adapter with a flushing device and pipe illustrated in the proper locations; and

FIG. 4 is a cross-section of an adapter along line B-B from FIG. 1 showing the arrangement of the adapter and flushing device during use.

### DETAILED DESCRIPTION OF THE PREFERRED EMBODIMENT

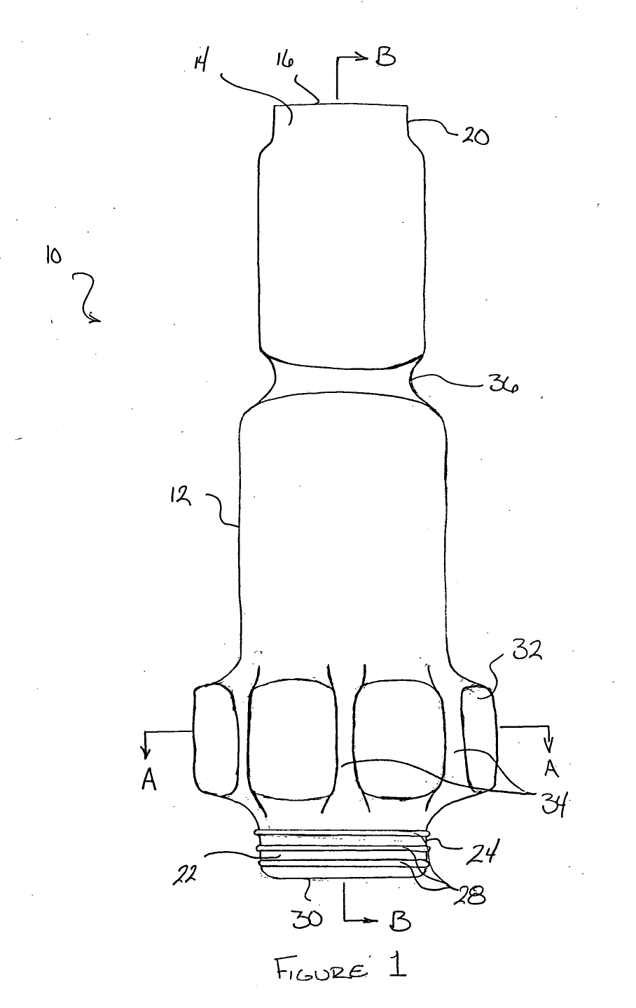

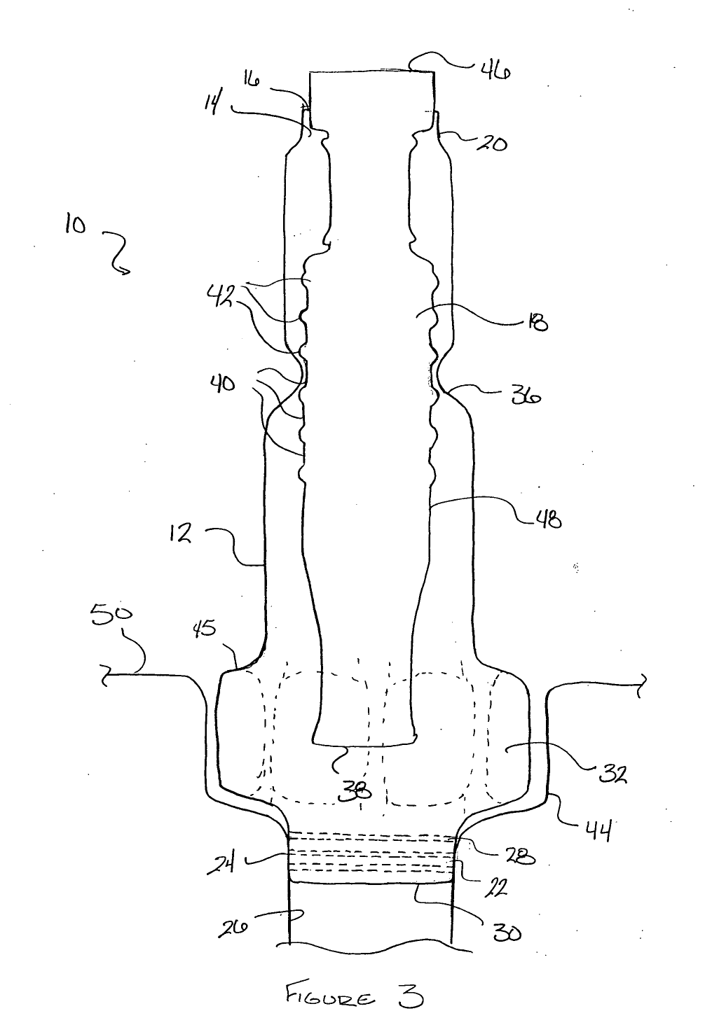

FIG. 1 illustrates a general view of an adapter 10. The adapter 10 has a main body 12. A first end 14 of the main body 12 has a first opening 16, for receiving a flushing device 18 (shown in FIG. 3). The first end 14 includes a neck portion 20 having a smaller diameter than the main body 12. The smaller diameter of the neck portion 20 assists in retaining the flushing device 18 in an upright position. However, the diameters of the first opening 16 and neck portion 20 are large enough to easily receive the flushing device 18. Indent 36 is located on the main body 12, between the second end 22 and the neck portion 20. The diameter of the indent 36 is smaller than the diameter of the main body 12.

A second end 22 is located at an opposing end of the main body 12 from the first end 14. The second end 22 has an insertion portion 24 to be inserted into a drainpipe 26 (shown in FIG. 3) during operation. The insertion portion 24 has a smaller diameter than the main body 12 to accommodate for the size of the drainpipe 26. Rings 28 run concentric about the insertion portion 24 and have a larger diameter than the insertion portion 24 and the drainpipe 26 to create a seal between the adapter 10 and the drainpipe 26. The second end 22 has a second opening 30 located at the bottom of insertion portion 24. The second opening 30 allows water from the flushing device 18 to pass through to the drainpipe 26 during operation.

An enlarged portion 32 is located on the main body 12 adjacent the insertion portion 24. The enlarged portion 32 has a larger diameter than the main body 12. The size and position of the enlarged portion 32 correspond to a sink recess 44 (shown in FIG. 3) when the adapter is in use. Striations 34 are included on the enlarged portion 32 and run from the insertion portion 24 all the way to the main body 12. The striations 34 follow the same curvature as the enlarged portion 32 along the length of the adapter 10.

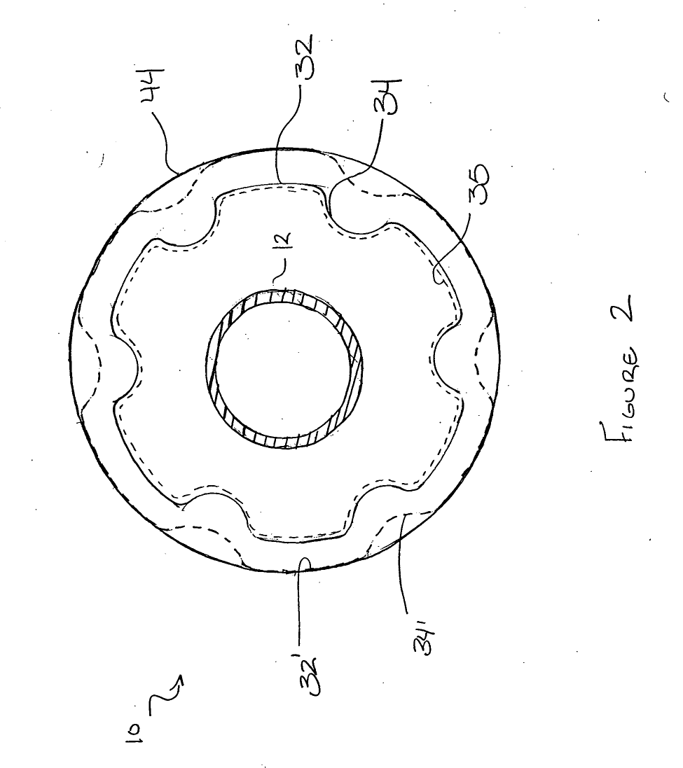

FIG. 2 shows a cross-section of the adapter 10, along line A-A, through the enlarged portion 32. The striations 34 have a smaller diameter than the enlarged portion 32. Thus, when the enlarged portion 32, comes into contact with a sink recess 44 the striations 34 provide a vent allowing water to pass through. As shown in one embodiment the striations 34 have an arcuate cross-section. Although the main body 12 of the adapter 10 is generally rigid the enlarged portion 32 may expand under pressure. The striations 34 assist the enlarged portion 32 in expanding, even through made from a generally rigid material, such as a plastic. The main body 12 does not have striations, thus is not expandable. The change in cross-section of the enlarged portion 32′ when under pressure is shown in phantom. Alternatively, the enlarged portion 32 may have a thinner wall 35 then the main body 12, thus making the material less rigid, and expandable.

Referring to FIG. 3 a cross-section of the adapter 10 is shown. The adapter 10 is inserted into the drainpipe 26 and the flushing device 18 is received through the first opening 16. As shown, the first opening 16 and neck portion 20 are larger in diameter than the flushing device 18. The flushing device 18 is inserted to a distance where an exit end 38 of the flushing device 18 has entered the enlarged portion 32, but not far enough to enter the insertion portion 24. A minimum distance between the exit end 38 and the second opening 30 must be maintained to allow for elongation of the flushing device 18 during operation. The flushing device 18 includes a series of recesses 40 for alignment with the indent 36 on the adapter 10. Protrusions 42 between the recesses 40 provide feedback as the user is inserting the flushing device 18 into the adapter 10, allowing the user to determine when the flushing device 18 has been inserted the proper distance into the adapter 10.

The second end 22 of the adapter 10 is inserted into a drainpipe 26. The rings 28 form an interference fit with the drainpipe 26. When the adapter 10 is inserted into the drainpipe 26 the enlarged portion 32 easily fits within a sink recess 44. During operation the enlarged portion 32 interacts with the sink recess 44 to hold the adapter 10 in an upright position, compensating for the weight of the flushing device 18, and the water source.

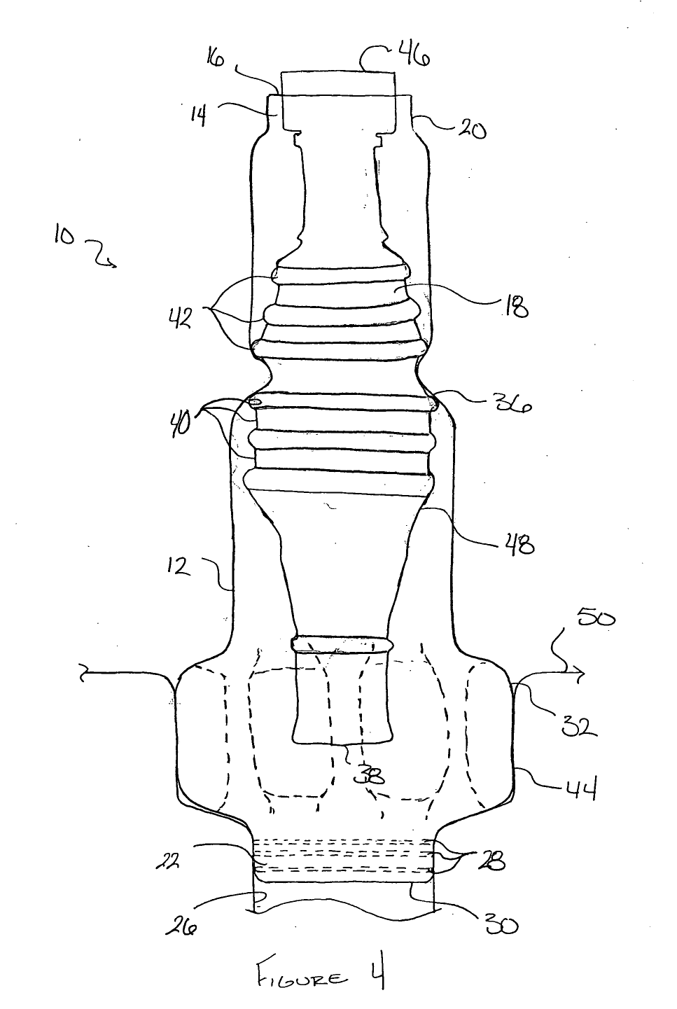

FIG. 4 shows the adapter 10 when the flushing device 18 is being operated. The flushing device 18 is connected to the water source at an entrance end 46. An internal valve (not shown) allows water pressure to build within the flushing device. As pressure builds the walls 48 of the flushing device 18 expand. The main body 12 of the adapter 10 is rigid. Thus, as the flushing device 18 expands it is locked into place by the indent 36, which corresponds to one of the recesses 40. Once the water pressure has reached a sufficient level the valve in the flushing device 18 opens and releases the water. The water flows through the second opening 30 into the drainpipe 26. The building and releasing of water pressure creates a pulsing action that can be repeated until the blockage is removed.

Occasionally pulsing of the water is not enough to clear the blockage and water will begin to back up in the drainpipe 26. The water will back up until it enters the adapter 10, through the second opening 30. As water is continuously pulsed out of the flushing device 18 the pressure of water in the drainpipe 26 and the adapter 10 increases. When this occurs the striations 34 allow the enlarged portion 32 to expand as a result of the pressure. The enlarged portion 32 will then contact sink recess 44. The contact pressure between the enlarged portion 32 and the sink recess 44 is proportional to the water pressure in the adapter 10. Thus, as the pressure in the adapter 10 increases the contact pressure between the enlarged portion 32 and the sink recess 44 will help to retain the adapter 10 in the drainpipe 26. If additional pressure is needed to retain the adapter in place the enlarged portion 32 provides a surface 45 on which downward pressure may easily be applied, reducing the efforts of the user.

If the increase of water pressure becomes great enough to cause leaks between the drainpipe 26 and the rings 28 then water may enter the sink recess 44. The striations 34 in the enlarged portion 32 allow this water to pass through to the sink bottom 50. Allowing any water leakage to pass through will prevent pressure from building between the enlarged portion 32 and the sink recess 44 that would force the adapter out of the drainpipe 26.

Eventually the water pressure will reach a high enough level to force the drainpipe clear. At this point the water pressure in the adapter 10, and flushing device 18 decreases. The water source may be shut off and the adapter 10 and flushing device 18 may be easily disassembled.

Although a preferred embodiment of this invention has been disclosed, a worker of ordinary skill in this art would recognize that certain modifications would come within the scope of this invention. For that reason, the following claims should be studied to determine the true scope and content of this invention.

1. A drain cleaning adapter comprising:
a main body;
a first end of said main body having a first opening for receiving a flushing device;
a second end opposing said first end, said second end having a second opening for allowing discharge of a fluid; and
an enlarged portion between said first end and said second end wherein said enlarged portion is expandable.

2. The drain cleaning adapter of claim 1, wherein said enlarged portion has at least one striation.

3. The drain cleaning adapter of claim 3, wherein said at least one striation extends from said main body to said second end.

4. The drain cleaning adapter of claim 1, wherein said main body end has at least one indent concentric about said main body, between said enlarged portion and said first end.

5. The drain cleaning adapter of claim 4, wherein said indent has a smaller diameter than said main body.

6. The drain cleaning adapter of claim 5, wherein said indent corresponds to recesses on said flushing device.

7. The drain cleaning adapter of claim 1, wherein said second end has an insertion portion for inserting into a drainpipe.

8. The drain cleaning adapter of claim 7, wherein said insertion portion has concentric rings for sealing against the drainpipe.

9. The drain cleaning adapter of claim 8, wherein said concentric rings form an interference fit with the drainpipe.

10. The drain cleaning adapter of claim 1, wherein said first end has a neck portion having a smaller diameter than said main body.

11. The drain cleaning adapter of claim 1, wherein said main body is rigid.

12. The drain cleaning adapter of claim 1, wherein said enlarged portion is expandable as a result of fluid pressure within the adapter.

13. A method of using a drain cleaning adapter comprising:
a) inserting a flushing device into a first end of a main body;
b) inserting a second end of the main body into a drainpipe; and
c) expanding an enlarged portion with water such that the enlarged portion contacts a sink recess.

14. The method of claim 13, wherein said step a) includes aligning at least one recess on the flushing device with an indent on the main body.

15. The method of claim 13, wherein said step b) includes forming a seal between the second end and the drainpipe.

16. The method of claim 13, wherein said step c) includes releasing water from the flushing device to create water pressure in the enlarged portion.

17. The method of claim 13, wherein said step c) includes creating pressure between the enlarged portion and the sink recess to retain the adapter in the drainpipe.

18. A drain cleaning adapter comprising:
a main body having a first end with a first opening for receiving a flushing device;
a second end opposing said first end, said second end having an insertion portion for inserting into a drain pipe and a second opening for allowing discharge of a fluid;
a indent on said main body disposed between said first end and said second end; and
an enlarged portion between said first end and said second end wherein said enlarged portion is expandable as a result of fluid pressure within the adapter.

19. The drain cleaning adapter of claim 18, wherein said enlarged portion has at least one striation.

20. The drain cleaning adapter of claim 19, wherein said at least one striation extends from said main body to said second end.
